(19) United States
(12) Patent Application Publication
(10) Pub. No.: US 2022/0092335 A1
(43) Pub. Date: Mar. 24, 2022

(54) SYSTEM AND METHOD FOR DETERMINING STANDARDIZED DATASETS USING OPTIMAL FEATURES

(71) Applicant: STOA USA, INC., NORTH MIAMI BEACH, FL (US)

(72) Inventor: Or AGASSI, Tel Aviv (IL)

(73) Assignee: STOA USA, INC., NORTH MIAMI BEACH, FL (US)

(21) Appl. No.: 17/448,152

(22) Filed: Sep. 20, 2021

Related U.S. Application Data
(60) Provisional application No. 63/080,178, filed on Sep. 18, 2020.

(51) Int. Cl. G06K 9/62

(52) U.S. Cl. CPC G06K 9/623; G06K 9/6256; G06K 9/6215; G06K 9/6219; G06K 9/6262

(57) ABSTRACT

A system and method for determining standardized datasets using optimal features. A method includes clustering a plurality of first datasets with respect to a plurality of tiers; determining an optimal feature for comparable parameters within each tier by applying standardization rules, wherein the standardization rules define a most reoccurring feature, wherein each optimal feature has the most reoccurring feature for a comparable parameter within a tier; generating a standardized dataset for each tier, wherein the standardized dataset generated for each tier includes each optimal feature determined for the tier; and generating a scope of work based on a second dataset and the standardized datasets, wherein the scope of work includes a recommendation to change each of at least one feature represented by the second dataset into a respective optimal feature of a target standardized dataset among the generated standardized datasets.

### CROSS-REFERENCE TO RELATED APPLICATIONS

This application claims the benefit of U.S. Provisional Application No. 63/080,178 filed on Sep. 18, 2020, the contents of which are hereby incorporated by reference.

### TECHNICAL FIELD

The present disclosure relates generally to data processing, and more specifically to objective rule-based processing to improve accuracy and reproducibility of data processing.

### BACKGROUND

In the field of data processing, sorting data into appropriate categories can result in better processing. This improvement is particularly important when large amounts of data are involved. Even though much technological advancements have become available in most industrial areas, in the real-estate domain, a massive use of manual labor is still being performed for tedious and costly steps.

House flipping is a type of real estate investment strategy in which an investor purchases real estate properties with the goal of reselling them for a profit. Profit is generated either through price appreciation, developments, and/or capital improvements. Investors who employ these strategies face a risk of not knowing what would be the elements that a potential buyer would look for in a renovated real estate property. These elements, such as, type of floor, marvel quality, etc., may be the differentiator that enables to complete a quick and profitable sale of the renovated real estate property.

Renovation of real estate properties requires selections from numerous, almost unending, choices of elements for the property. However, investors who flip houses usually determine what elements should be replaced or renovated based on their professional experience and taste which is subjective and inefficient. Such subjective decisions may not align with expectations of potential buyers and can cause delays in the time to sell the property, which can become costly to the owner.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining standardized datasets using optimal features. The method comprises: clustering a plurality of first datasets with respect to a plurality of tiers, wherein each of the plurality of first datasets includes values representing a plurality of comparable parameters; determining an optimal feature for at least one of the plurality of comparable parameters within each tier by applying standardization rules, wherein the standardization rules define a most reoccurring feature for a comparable parameter among the plurality of first datasets, wherein the optimal feature for one of the plurality of comparable parameters within a tier has the most reoccurring feature for the at least one comparable parameter within the tier; generating a standardized dataset for each tier, wherein the standardized dataset generated for each tier includes each optimal feature determined for the tier; and generating a scope of work based on a second dataset and the standardized datasets, wherein the scope of work includes a recommendation to change each of at least one feature represented by the second dataset into a respective optimal feature of a target standardized dataset among the generated standardized datasets.

Certain embodiments disclosed herein also include a non-transitory computer readable medium having stored thereon causing a processing circuitry to execute a process, the process comprising: clustering a plurality of first datasets with respect to a plurality of tiers, wherein each of the plurality of first datasets includes values representing a plurality of comparable parameters; determining an optimal feature for at least one of the plurality of comparable parameters within each tier by applying standardization rules, wherein the standardization rules define a most reoccurring feature for a comparable parameter among the plurality of first datasets, wherein the optimal feature for one of the plurality of comparable parameters within a tier has the most reoccurring feature for the at least one comparable parameter within the tier; generating a standardized dataset for each tier, wherein the standardized dataset generated for each tier includes each optimal feature determined for the tier; and generating a scope of work based on a second dataset and the standardized datasets, wherein the scope of work includes a recommendation to change each of at least one feature represented by the second dataset into a respective optimal feature of a target standardized dataset among the generated standardized datasets.

Certain embodiments disclosed herein also include a system for determining standardized datasets using optimal features. The system comprises: a processing circuitry; and a memory, the memory containing instructions that, when executed by the processing circuitry, configure the system to: cluster a plurality of first datasets with respect to a plurality of tiers, wherein each of the plurality of first datasets includes values representing a plurality of comparable parameters; determine an optimal feature for at least one of the plurality of comparable parameters within each tier by applying standardization rules, wherein the standardization rules define a most reoccurring feature for a comparable parameter among the plurality of first datasets, wherein the optimal feature for one of the plurality of comparable parameters within a tier has the most reoccurring feature for the at least one comparable parameter within the tier; generate a standardized dataset for each tier, wherein the standardized dataset generated for each tier includes each optimal feature determined for the tier; and generate a scope of work based on a second dataset and the standardized datasets, wherein the scope of work includes a recommendation to change each of at least one feature represented by the second dataset into a respective optimal feature of a target standardized dataset among the generated standardized datasets.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to discuss the various disclosed embodiments.

FIG. 2 is a schematic diagram of a server according to an embodiment.

FIG. 3 is a flowchart illustrating a method for generating a standardized dataset according to an embodiment.

FIG. 4 is a flowchart illustrating a method for generating a scope of work according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments provide a system and method for efficiently and accurately determining a standardized dataset using optimal features of real estate properties (REPs) to provide a standardized guideline for renovating and upgrading a real estate property (REP). The disclosed embodiments present an objective rules-based process that enables thorough analyses of data to provide consistent and reproducible decision outputs.

It has been identified that current approaches to making renovation decisions are often subjective, based on an individual's and/or group's professional experience, biases, and preferences. An owner and/or investor may manually gather information and perform some comparison between the limited number of REPs and associated comparable parameters. In this case, a decision is made relying on a small pool of datasets in absence of any rule for objective and comprehensive analysis of the REPs available. Furthermore, the manual comparison approach can be time consuming and inefficient. To this end, in an embodiment, standardization rules are utilized to efficiently and reliably identify the optimal features (i.e., the most reoccurring feature) of comparable parameters from multiple sample datasets.

More specifically, in an embodiment, the standardization rules define a most reoccurring feature for the comparable parameters with respect to a category represented by the comparable parameters and values for the category among a plurality of first sample datasets. These optimal features identified using the standardization rules may be merged to generate standardized datasets with respect to certain tiers. The standardized datasets can serve as guidelines to be compared to a second subject dataset in order to identify potential modifications to a parcel represented by the subject dataset. The second subject dataset may represent a parcel, i.e., a piece of land on which a real estate property (REP) is located, for which an owner and/or investor is looking to renovate. According to the disclosed embodiments, renovation decisions on the subject parcel can be made objectively based on values of a standardized dataset in order to result in an optimal parcel as compared to similarly situated parcels (i.e., parcels within the same tier).

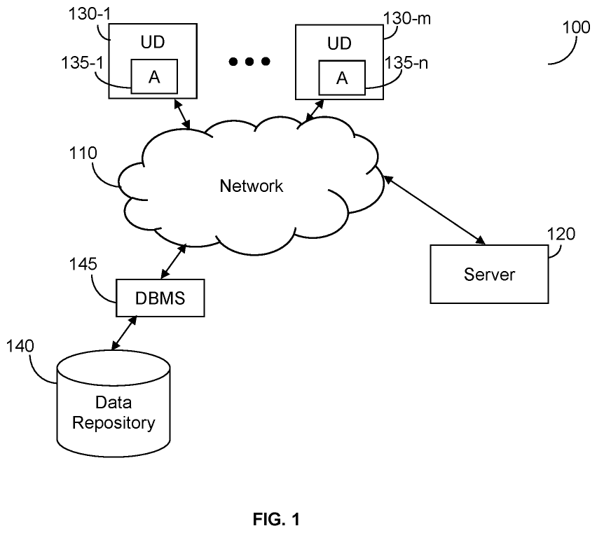

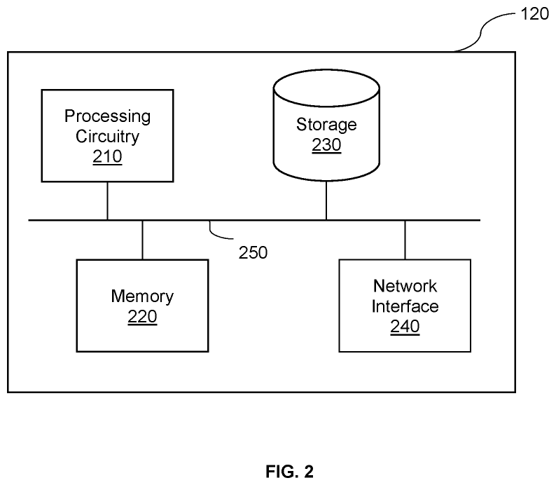

FIG. 1 is a network diagram 100 utilized to discuss the various disclosed embodiments. A server 120 is connected to a network 110. The server 120 and its components are described below in more detail with respect of FIG. 2. The network 110 is used to communicate in accordance with the disclosed embodiments. The network 110 may be, but is not limited to the Internet, the world-wide-web (WWW), a local area network (LAN), a wide area network (WAN), a metro area network (MAN), and other similar networks, and any combination thereof.

Optionally, one or more user devices 130-1 through user device 130-m (referred to individually as user device 130 and collectively as user devices 130, where m is an integer greater than 1) may be communicatively connected to the server 120 through the network 110.

A user device 130 may be, for example, a smart phone, a mobile phone, a laptop, a tablet computer, a wearable server, a personal computer (PC), a smart television and other kinds of wired and/or mobile appliances equipped with browsing, viewing, capturing, storing, listening, filtering, and managing capabilities.

The user device 130 may be configured to send to and receive from the server 120 data, metadata, datasets, and the like that relates to, e.g., a subject property, a sample property, a purchase price, a sale price, features (or characteristics) made throughout a refurbishment of each property, and so on. Each user device 130 may further include a respective software application (App) 135 installed thereon. An App 135 may be downloaded from an application repository, such as Apple® AppStore®, Google® Play®, or any repositories hosting software applications. The application 135 may be pre-installed in the user device 130. In an embodiment, the application 135 is a web-browser.

It should be noted that only one user device 130 and one application 135 are discussed herein merely for the sake of simplicity. However, the embodiments disclosed herein are applicable to a plurality of user devices 130 that can communicate with the server 120 through the network 110.

A data repository 140 may be communicatively connected to the server 120 through the network 110, or embedded within the server 120. The data repository 140 may be communicatively connected to the network 110 through a database management service (DBMS) 145, which is a system software for creating and managing databases. The data repository 140 may be, for example, a storage device containing a database, a data warehouse, and the like. The data repository 140 may be used to store datasets associated with various property purchase prices, property sale prices, metadata associated with properties, datasets associated with updated features made throughout refurbishment processes of properties such as the upgrade cost, timeline of upgrade completion, increase of value associated with the upgrade, combinations thereof, and so on.

According to various disclosed embodiments, the server 120 receives a plurality of first sample datasets associated with a plurality of first sample parcels, where a parcel is piece of land including a real estate property (REP) on it. The sample datasets may include, without limitation, data, metadata, specifications, multimedia content, address information, and the like. Each sample dataset includes fields and values for comparable parameters representing different categories of parcel characteristics such as, but not limited to, number of bedrooms, color of kitchen wall, and the like. Each field represents a respective category of characteristic (e.g., number of bedrooms) and has a corresponding value representing the characteristic (e.g., the specific number of bedrooms of a REP on the parcel). In an embodiment, the plurality of first sample datasets may be stored at the data repository 140. In another embodiment, the plurality of first sample datasets may be received as inputs from the user device 130.

Moreover, in the disclosed embodiments, the server 120 receives a second subject dataset of a subject parcel that includes a subject real estate property (REP). The subject dataset may be received from a user device (e.g., the user device 130-1). The user device may be, for example, associated with a person that is, for example, the owner of the REP which may also be an investor that is looking for renovating the REP and sell it thereafter. The subject dataset may include, for example and without limitation, data, metadata, multimedia of the REP, specification of the REP, address information, and so on.

As a non-limiting example, a dataset (e.g., one of the first sample datasets or the second subject dataset) may indicate that the respective parcel is located in Miami, Florida, the particular address of the parcel, that a REP on the parcel includes five bedrooms and two bathrooms, the size of each room, and the like. The dataset may also indicate the general condition of the REP or parcel, the condition of each part of the REP, and the like. As noted above, the dataset may include multimedia content such that according to some embodiments, in order to detect some of the features of the REP, an analysis of the multimedia content may be performed. In an embodiment, the analysis of the multimedia content may be achieved using, for example and without limitations, one or more computer vision techniques, machine learning techniques, and the like.

In an embodiment, standardized datasets may be determined at the server 120 based on the plurality of first sample datasets associated with the plurality of first sample parcels. The standardized dataset includes a set of optimal features or characteristics that are identified using an objective rules-based process as the most reoccurring among all or at least most of the parcels of a certain tier. A tier may be defined with respect to, for example but not limited to, a range of prices of parcels (i.e., such that parcels in the same general price range are compared for each standardized dataset), a certain REP owner (such as a certain real estate company, venture capital firm, etc.) (i.e., such that parcels owned by the same entity are compared for each standardized dataset), and the like.

Each standardized dataset includes values for optimal features of comparable parameters of a standardized parcel represented by the standardized dataset. In an embodiment, the plurality of standardized datasets for each tier may be stored in the data repository 140. In an embodiment, the standardized dataset may represent an ideal parcel within the tier, i.e., a parcel having the most reoccurring features among parcels in the tier such that the standardized parcel represented by that standardized dataset includes the objectively most optimal characteristics.

In furtherance of the above, a search for standardized datasets with a similarity score greater than a predetermined threshold value is performed for a second subject dataset representing a subject parcel to be improved, and one of the target standardized datasets having a similarity score above the threshold is identified. The similarity score indicates the level of similarity between the subject dataset (of the subject REP) and a standardized dataset as determined with respect to the comparable parameters, and may be determined using similarity rules defining a degree of similarity with respect to factors such as, but not limited to, number of parameters in common, weights of common parameters, combinations thereof, and the like. The predetermined threshold value may be a number indicating the difference between similar and dissimilar subject dataset and at least a standardized dataset.

As a non-limiting example, the subject dataset indicates that the subject parcel includes a 1700 square feet (SQFT) house having four bedrooms, located in Houston, Texas. According to the same example, the identified standardized dataset having a similarity score greater than the predetermined threshold, is indicative of a standardized parcel located in Houston, Texas, determined based on sample datasets for parcels that are over 1500 SQFT and under 1800 SQFT.

In an embodiment, a scope of work may be generated at the server 120 for renovating the subject parcel based on the identified standardized dataset that has a similarity score above a threshold with the subject dataset. The generated scope of work indicates recommendations for modifications to the subject parcel in order to match certain comparable parameters indicated by the identified standardized dataset. In an embodiment, for each comparable parameter whose respective value does not match between the subject dataset and the identified standardized dataset, the scope of work indicates a recommendation to change the subject parcel to match the standardized parcel represented by the standardized dataset with respect to that comparable parameter. For example, the scope of work may indicate that a current floor which is not a hard wood floor should be removed and that a hard wood floor should be installed instead, the rooms should be painted in white instead of their current colors, all existing faucets should be removed and that a particular type of faucets should be installed instead of the old faucets, and so on.

In an embodiment, the server 120 may be configured to generate an electronic notification that includes the scope of work. The electronic notification may be any kind of an electronic notice such as an electronic message. In a further embodiment, the server 120 may be configured to send the electronic notification to a user device (e.g., the user device 130-1) of a user that is, for example, the owner of the subject parcel. Thus, the owner of the subject parcel automatically and quickly receives an accurate recommendation of a desirable renovation process in order to update the subject parcel to fit into a specific standard of real estate properties of a specific tier.

According to one embodiment, based on the generated scope of work, the server 120 may be further configured to generate a bid for purchasing the subject parcel from the owner. The bid may be determined based on, but not limited to, the estimated cost of the scope of work calculated using the recommended modifications and a predetermined list of average costs of various types of modifications. According to another embodiment, based on the generated scope of work, the server 120 may be configured to generate an offer for funding the renovation process.

FIG. 2 shows an example schematic diagram of a server 120 according to an embodiment. The server 120 includes at least one processing circuitry 210, for example, a central processing unit (CPU). In an embodiment, the processing unit 210 includes, or is a component of, a larger processing unit implemented with one or more processors. The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), general-purpose microprocessors, microcontrollers, digital signal processors (DSPs), and the like, or any other hardware logic components that can perform calculations or other manipulations of information. The processing circuitry 210 is coupled via a bus 250 to a memory 220.

The memory 220 may be configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. In one configuration, software for implementing one or more embodiments disclosed herein may be stored in the storage 230.

The memory 220 may be further used as a working scratch pad for the processing circuitry 210, a temporary storage, and others, as the case may be. The memory 220 may be a volatile memory such as, but not limited to random access memory (RAM), non-volatile memory (NVM), such as, but not limited to, flash memory, or a combination thereof.

The processing circuitry 210 may be coupled to a network interface 240, such as a network interface card, for providing connectivity between the server 120 and a network (e.g., network 110, FIG. 1). The processing circuitry 210 may be further coupled with a storage 230. The storage 430 may be magnetic storage, optical storage, and the like, and may be realized, for example, as flash memory or other memory technology, compact disk- read only memory (CD-ROM), Digital Versatile Disks (DVDs), or any other medium which can be used to store the desired information. The storage 230 may be used for the purpose of storing properties purchase price, properties sale price, metadata associated with properties, datasets associated with updated features made throughout refurbishment processes of properties such as the upgrade cost, and so on.

It should be understood that the embodiments described herein are not limited to the specific architecture illustrated in FIG. 2, and other architectures may be equally used without departing from the scope of the disclosed embodiments.

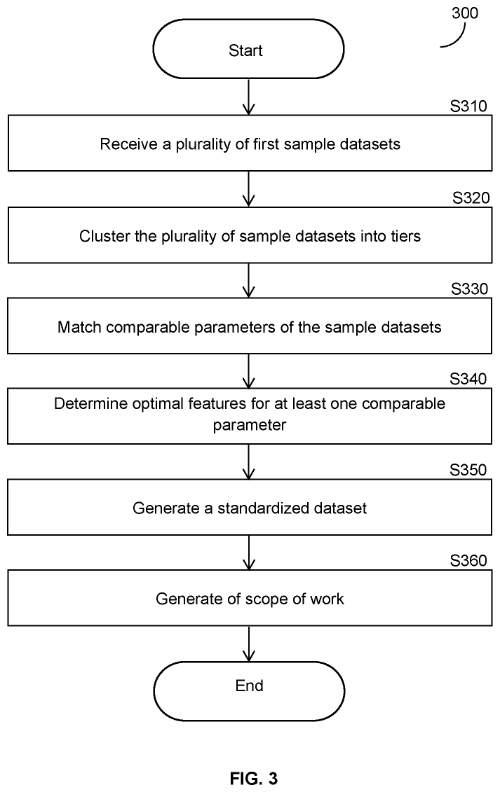

FIG. 3 is an example flowchart 300 illustrating a method for generating a standardized dataset according to an embodiment.

At S310, a plurality of first sample datasets is received. In an embodiment, each sample dataset may be associated with a respective first sample parcel. Each parcel is a piece of land with a real estate property (REP). The sample dataset may include, but not limited to, data, metadata, specification, multimedia content, and address information indicating comparable parameters of the parcel and associated REP.

At S320, the plurality of sample datasets is clustered into tiers. Each tier defines a subset of the plurality of sample datasets representing sample parcels having one or more characteristics in common. Such characteristics may include, but are not limited to, price, size, number of rooms, and more. As a non-limiting example, a tier may include all parcels having a price in the range of $100,000 to $200,000. In a further embodiment, the tier may be defined with respect to a certain owner of REPs such as, for example, a real estate company, a venture capital firm, and the like. In an embodiment, a certain sample dataset may be clustered into one or more tiers with respect to the characteristics of the REP associated with the certain sample dataset.

At S330, comparable parameters of the sample datasets within each tier are matched. In an embodiment, the comparable parameters may indicate categories including, but not limited to, size, address, type of floor, type of faucet, and the like. The comparable parameters of the plurality of sample datasets are matched in order to determine how many parcels share each possible value of the comparable parameters.

As noted above, the sample datasets may include multimedia content. To this end, in some embodiments, S330 may include analyzing such multimedia content (e.g., using machine vision) in order to identify one or more values for comparable parameters of any dataset including multimedia content. In this regard, multimedia content may be used to identify characteristics of a property without requiring that those characteristics be explicitly provided.

At S340, an optimal feature is determined for each of at least one comparable parameter with respect to each tier based on the matching. In an embodiment, S340 includes applying standardization rules defining a most reoccurring feature for a given comparable parameter with respect to a category represented by the comparable parameter and values for the category among the sample datasets within the tier. As a non-limiting example, among the sample datasets within a tier, “white” may be the most reoccurring feature for a comparable parameter which corresponds to a category “kitchen wall color.” This category may be represented by a respective field within the datasets. In this example, “white kitchen wall color” will be determined as the optimal feature for the respective comparable parameter among the sample datasets within the tier.

In an embodiment, the optimal feature may be determined for some or all comparable parameters of the sample datasets of the tier. To this end, a threshold number or proportion of instances of the value may be required in order to determine that the value represents an optimal feature. As a non-limiting example, the threshold may be 100 such that a value “white” for the comparable parameter “kitchen wall color” is only determined as the optimal feature for a given tier when at least 100 of the sample datasets clustered into the tier include “white” as the value for the field representing “kitchen wall color.”

At S350, a standardized dataset is generated for each tier based on the optimal features determined for the tier. The determined optimal features may be merged together to form the standardized dataset including the optimal feature of at least one comparable parameter for the tier. In an embodiment, each standardized dataset represents a hypothetical standardized parcel including a set of features common among all or at least most of the parcels of a certain tier. As noted above, because the optimal features are determined objectively based on how often their respective values occur in the sample datasets, generating standardized datasets including those optimal features allows for objectively identifying a parcel having characteristics which are likely to be ideal for a given tier, e.g., such that the parcel would be most desirable among parcels in the same tier.

At S360, a scope of work is generated based on standardized datasets and a second subject dataset. In an embodiment, the subject dataset represents a subject parcel of interest in which an owner and/or investor is looking to update and sell it thereafter. The subject dataset may include, for example, without limitation, data, metadata, multimedia of the REP, specification of the REP, address information, and so on.

In an embodiment, the scope of work includes recommendations to modify features of the subject parcel based on optimal features of one of the standardized datasets. In a further embodiment, the scope of work includes recommendations to change the subject parcel based on a standardized dataset which is most similar to the subject parcel (i.e., based on a similarity score determined between the subject dataset and each standardized dataset). Accordingly, the scope of work may include recommending changes to make the subject parcel more like an ideal parcel having similar characteristics.

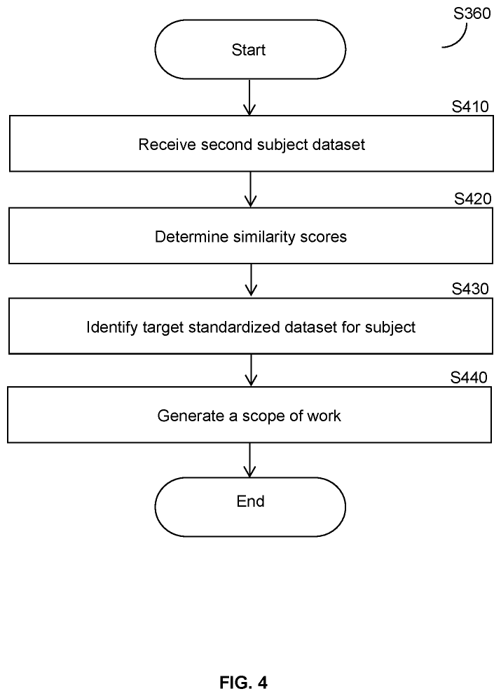

In an embodiment, the scope of work may be generated as described with respect to FIG. 4. FIG. 4 is an example flowchart S360 illustrating a method for generating a scope of work according to an embodiment.

At S410, a second subject dataset is received. In an embodiment, the subject dataset may be associated with a parcel of interest and include, for example and without limitation, multimedia content showing the parcel, specifications of a REP of the parcel, address information, and the like.

At S420, similarity scores are determined. Each similarity score represents a degree of similarity between the subject dataset and one of the standardized datasets, and is determined using similarity rules. The similarity rules define degrees of similarity with respect to factors such as, but not limited to, a number of matching values of each comparable parameter between the subject dataset and the standardized dataset, weights of different comparable parameters, combinations thereof, and the like.

At S430, a target standardized dataset is determined for the subject based on the similarity scores and the subject dataset. In an embodiment, the target standardized dataset has a similarity score with the subject dataset above a predetermined threshold. As noted above, each standardized dataset includes optimal features for at least one comparable parameter within a given tier. It should be noted that there may be more than one potential target standardized dataset, i.e., multiple standardized datasets may have a similarity score above the threshold with a given subject dataset. In such a case, multiple target standardized datasets may be identified such that multiple potential scopes of work may be generated. Alternatively, the target standardized dataset may be, for example but not limited to, a standardized dataset having the highest similarity score with the subject dataset, a potential target standardized dataset having the fewest number of optimal features that differ from respective values of the subject dataset, and the like.

At S440, a scope of work is generated based on the target standardized dataset and the subject dataset. In an embodiment, the scope of work includes a recommendation to change at least one feature of the subject parcel represented by the subject dataset, based on the optimal features of the target standardized parcel represented by the target standardized dataset. In an embodiment, S440 further includes generating and sending an electronic notification that includes the scope of work.

When multiple target standardized datasets are determined, the scope of work may include recommendations for changing features of the subject parcel with respect to each optimal feature of each target standardized dataset. Alternatively, multiple scopes of work may be generated (i.e., a scope of work may be generated for each target standardized dataset).

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining standardized datasets using optimal features, comprising:
clustering a plurality of first datasets with respect to a plurality of tiers, wherein each of the plurality of first datasets includes values representing a plurality of comparable parameters;
determining an optimal feature for at least one of the plurality of comparable parameters within each tier by applying standardization rules, wherein the standardization rules define a most reoccurring feature for a comparable parameter among the plurality of first datasets, wherein the optimal feature for one of the plurality of comparable parameters within a tier has the most reoccurring feature for the at least one comparable parameter within the tier;
generating a standardized dataset for each tier, wherein the standardized dataset generated for each tier includes each optimal feature determined for the tier; and
generating a scope of work based on a second dataset and the standardized datasets, wherein the scope of work includes a recommendation to change each of at least one feature represented by the second dataset into a respective optimal feature of a target standardized dataset among the generated standardized datasets.

2. The method of claim 1, wherein each tier includes a subset of the plurality of first datasets having at least one represented characteristic in common.

3. The method of claim 1, further comprising:
determining a similarity score between each of the plurality of standardized datasets and the second dataset based on the comparable parameters of each of the plurality of the standardized datasets and of the second dataset; and
identifying the target standardized dataset based on the determined similarity scores.

4. The method of claim 3, wherein the target standardized dataset has a similarity score with the second dataset above a predetermined threshold.

5. The method of claim 3, wherein each similarity score determined for a given pair of datasets is determined based further on at least one of: a number of matching comparable parameters between the pair of datasets, and a weight of each comparable parameter matching between the pair of datasets.

6. The method of claim 1, wherein determining the optimal features further comprises:
matching comparable parameters of the plurality of first datasets within each tier, wherein the most reoccurring value for each comparable parameter within one of the tiers is determined based on the number of matching values of the comparable parameter between first datasets of the tier.

7. The method of claim 1, wherein each of the plurality of first datasets includes multimedia content, wherein determining the optimal features further comprises:
analyzing, for each of the plurality of first datasets, the multimedia content of the first dataset to determine a value for at least one comparable parameter for the first dataset.

8. The method of claim 1, wherein each optimal feature for the comparable parameter of one of the tiers is represented by a value having at least a threshold number of instances of the value for the comparable parameter within the tier.

9. The method of claim 1, further comprising:
generating a notification indicating the scope of work.

10. A non-transitory computer readable medium having stored thereon instructions for causing a processing circuitry to execute a process, the processing comprising:
clustering a plurality of first datasets with respect to a plurality of tiers, wherein each of the plurality of first datasets includes values representing a plurality of comparable parameters;
determining an optimal feature for at least one of the plurality of comparable parameters within each tier by applying standardization rules, wherein the standardization rules define a most reoccurring feature for a comparable parameter among the plurality of first datasets, wherein the optimal feature for one of the plurality of comparable parameters within a tier has the most reoccurring feature for the at least one comparable parameter within the tier;
generating a standardized dataset for each tier, wherein the standardized dataset generated for each tier includes each optimal feature determined for the tier; and
generating a scope of work based on a second dataset and the standardized datasets, wherein the scope of work includes a recommendation to change each of at least one feature represented by the second dataset into a respective optimal feature of a target standardized dataset among the generated standardized datasets.

11. A system for determining standardized datasets using optimal features, comprising:
a processing circuitry; and
a memory, the memory containing instructions that, when executed by the processing circuitry, configure the system to:
cluster a plurality of first datasets with respect to a plurality of tiers, wherein each of the plurality of first datasets includes values representing a plurality of comparable parameters;
determine an optimal feature for at least one of the plurality of comparable parameters within each tier by applying standardization rules, wherein the standardization rules define a most reoccurring feature for a comparable parameter among the plurality of first datasets, wherein the optimal feature for one of the plurality of comparable parameters within a tier has the most reoccurring feature for the at least one comparable parameter within the tier;
generate a standardized dataset for each tier, wherein the standardized dataset generated for each tier includes each optimal feature determined for the tier; and
generate a scope of work based on a second dataset and the standardized datasets, wherein the scope of work includes a recommendation to change each of at least one feature represented by the second dataset into a respective optimal feature of a target standardized dataset among the generated standardized datasets.

12. The system of claim 11, wherein each tier includes a subset of the plurality of first datasets having at least one represented characteristic in common.

13. The system of claim 11, wherein the system is further configured to:
determine a similarity score between each of the plurality of standardized datasets and the second dataset based on the comparable parameters of each of the plurality of the standardized datasets and of the second dataset; and
identify the target standardized dataset based on the determined similarity scores.

14. The system of claim 13, wherein the target standardized dataset has a similarity score with the second dataset above a predetermined threshold.

15. The system of claim 13, wherein each similarity score determined for a given pair of datasets is determined based further on at least one of: a number of matching comparable parameters between the pair of datasets, and a weight of each comparable parameter matching between the pair of datasets.

16. The system of claim 11, wherein the system is further configured to:
match comparable parameters of the plurality of first datasets within each tier, wherein the most reoccurring feature for each comparable parameter within one of the tiers is determined based on the number of matching values of the comparable parameter between first datasets of the tier.

17. The system of claim 11, wherein each of the plurality of first datasets includes multimedia content, wherein the system is further configured to:
analyze, for each of the plurality of first datasets, the multimedia content of the first dataset to determine a value for at least one comparable parameter for the first dataset.

18. The system of claim 11, wherein each optimal feature for the comparable parameter of one of the tiers is represented by a value having at least a threshold number of instances of the value for the comparable parameter within the tier.

19. The system of claim 11, wherein the system is further configured to:
generate a notification indicating the scope of work.
